(19) United States
(12) Patent Application Publication
(10) Pub. No.: US 2026/0036185 A1
(43) Pub. Date: Feb. 5, 2026

(54) FIXED FASTENERS

(71) Applicant: KABA Labs, Inc., Austin, TX (US)

(72) Inventors: Karl Burkett, Austin, TX (US); Christopher Brown, Haverhill, MA (US); Marcus Van Kommer, Madbury, NH (US); Christopher Wolfe, Newmarket, NH (US)

(21) Appl. No.: 19/269,305

(22) Filed: Jul. 15, 2025

Related U.S. Application Data
(60) Provisional application No. 63/678,074, filed on Aug. 1, 2024.

(51) Int. Cl. F16G 11/12; F16B 45/02; H01R 4/66

(52) U.S. Cl. CPC F16G 11/12; F16B 45/02; H01R 4/66

(57) ABSTRACT

The system and method of fixedly attaching fixed fasteners within a light assembly that are configured to removably retain a breakaway connector and provide grounding to the system. The fixed fasteners are secured such that they do not move with respect to the surface they are attached to. The fixed fasteners may be made of conductive material. In some cases, the fixed fasteners withstand 400 lbs of pull.

### FIELD OF THE DISCLOSURE

The present disclosure relates to fasteners and more particularly to fixed fasteners for use with breakaway electrical and data connectors.

### BACKGROUND OF THE DISCLOSURE

Traffic lights utilize multiple conductors (wires/cables) to both power the traffic lights and to transfer signals. The conductors bridge the lights supported by a pole with controls mounted on the ground nearby the light pole. In the event of a traffic accident, for example, it is possible that a vehicle could impact the light pole, break it at the base, and knock it over. When the pole separates from the ground it pulls on the cables and wires, thus damaging them. This damage requires the wires and cables to be replaced.

Conventional connectors with safety features have conductors exposed to the elements, which can cause personal injury, corrode due to the elements, or short and damage the connector or devices attached to the connector. One existing safety connector for use with electric vehicles provides a wire (pilot conductor or non-conducting line) within the connector that is shorter than the conductor wires so it will be pulled off its contact before all of the slack in the power conductors is taken up. This results in a connector that will still be damaged when exposed to an external force. Other current solutions are “loose” fitting, which would allow a possible break in electrical bonding/conductivity as a part is moved and resting against adjacent parts.

Wherefore it is an object of the present disclosure to overcome the above-mentioned shortcomings and drawbacks associated with conventional fasteners in grounding systems.

### SUMMARY OF THE DISCLOSURE

One aspect of the present disclosure is an attachment system, comprising a fastener body, comprising: at least one planar portion; and a gate opposite the at least one planar portion; wherein the gate is pivotally attached to the body and has a free end, and the at least one planar portion is configured to be mechanically attached to a surface.

In some aspects, the techniques described herein relate to a system, wherein the fastener body is configured to receive a tether of a breakaway connector. In some aspects, the techniques described herein relate to a system, wherein the surface is an inside surface of a pole. In some aspects, the techniques described herein relate to a system, wherein the planar portion further includes a pair of recesses. In some aspects, the techniques described herein relate to a system, wherein fastener body is permanently attached using rivets via the pair of recesses. In some aspects, the techniques described herein relate to a system, wherein the pair of recesses are spaced along the planar portion of the body to distribute stress along a length of the planar portion.

Another aspect is an attachment system, comprising: a fastener body, comprising at least one planar portion; and a gate opposite the at least one planar portion; wherein the gate is pivotally attached to the body and has a free end, and the at least one planar portion is configured to be permanently attached to a surface along a length of the planar portion.

In some aspects, the techniques described herein relate to a system, wherein the fastener body is configured to receive a tether of a breakaway connector. In some aspects, the techniques described herein relate to a system, wherein the surface is a rod.

In some aspects, the techniques described herein relate to a system, wherein the planar portion includes a material. In some aspects, the techniques described herein relate to a system, wherein the fastener body is spaced a distance from a free end of the rod to accommodate a nut.

In yet another aspect, the techniques described herein relates to an attachment system, comprising: a first fastener body, comprising: a first planar portion; and a gate opposite the first planar portion; wherein the gate is pivotally attached to the first fastener body and has a free end, and the first planar portion is configured to be mechanically attached to a first surface; and a second fastener body, comprising: a second planar portion; and a gate opposite the second planar portion; wherein the gate is pivotally attached to the second fastener body and has a free end, and the second planar portion is configured to be permanently attached to a second surface along a length of the second planar portion.

In some aspects, the techniques described herein relate to a system, wherein the first fastener body is configured to receive a first tether of a breakaway connector and the second fastener body is configured to receive a second tether of a breakaway connector. In some aspects, the techniques described herein relate to a system, wherein the first planar portion further includes a pair of recesses. In some aspects, the techniques described herein relate to a system, wherein the first surface is an inside surface of a pole. In some aspects, the techniques described herein relate to a system, wherein the first fastener body is permanently attached using rivets via the pair of recesses.

In some aspects, the techniques described herein relate to a system, wherein the pair of recesses are spaced along the first planar portion of the body to distribute stress along the length of the first planar portion. In some aspects, the techniques described herein relate to a system, wherein the second surface is a rod. In some aspects, the techniques described herein relate to a system, wherein the second planar portion includes a material. In some aspects, the techniques described herein relate to a system, wherein the second fastener body is spaced a distance from a free end of the rod to accommodate a nut.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular implementations of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows implementations of fixed fasteners according to the principles of the present disclosure being used with a break away electrical and data connector.

FIG. 2 shows one implementation of a fixed fastener according to the principles of the present disclosure.

FIG. 3 shows one implementation of a fixed fastener according to the principles of the present disclosure.

FIG. 4 shows another implementation of a fixed fastener according to the principles of the present disclosure.

FIG. 5 shows another implementation of a fixed fastener according to the principles of the present disclosure.

### DETAILED DESCRIPTION OF THE DISCLOSURE

Typically, commercial or industrial light poles are bolted to a concrete pad and there are electrical and/or data cables in the base that are used to power and control the light. Traditional light pole assemblies are vulnerable to excessive damage if struck by a vehicle or the like. A breakaway connector is one way of mitigating this type of damage, but it is important to properly mount such breakaway connectors for maximum benefit. Certain implementations of fixed fasteners of the present disclosure mount the breakaway connector securely at the top and at the bottom of the breakaway connector and provide for grounding the system.

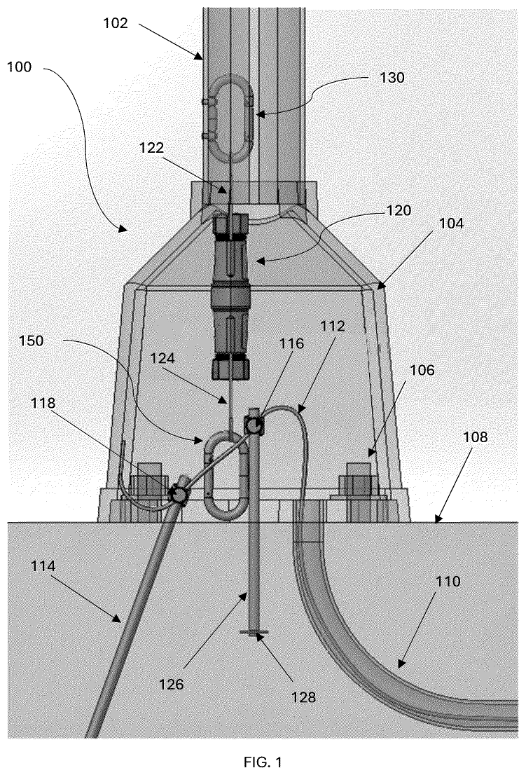

Referring to FIG. 1, implementations of fixed fasteners according to the principles of the present disclosure being used with a breakaway electrical and data connector are shown. More specifically, a base of a commercial or industrial light assembly is shown. A base of a commercial or industrial light assembly 100 is shown with a pole 102 and a footing 104 that is secured using bolts 106, or the like, to a footer or pad 108. In some cases, the footer or pad is made of concrete. In some cases, within the footer or pad 108 is a conduit 110 for housing a ground wire 112 that is configured to be connected to a ground rod 114 using a nut 116.

In certain implementations, a breakaway connector 120 having a first tether 122 and a second tether 124 is used. In one implementation, a first fixed fastener 130 is fixedly mounted inside a pole 102 to reversibly receive a first tether 122 of a breakaway connector 120. In one implementation, a second fixed fastener 150 is fixedly mounted to a rod 126 having a base portion 128, the second fixed fastener being configured to reversibly receive a second tether 124 of a breakaway connector 120. In certain implementations, the second fixed fastener 150 is fixedly mounted to a rod 126 a distance from a free end of the rod to accommodate a nut 116. In some cases, the rod 126 is held within the footer or pad 108 and is used to guide a ground wire 112 to a ground rod 114 via a nut 118 and to reversibly receive a second tether 124 of a breakaway connector 120.

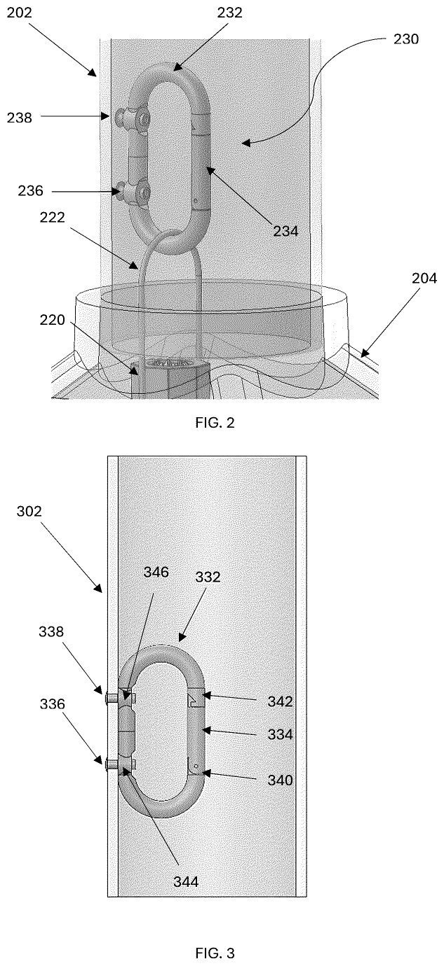

Referring to FIG. 2, one implementation of a fixed fastener according to the principles of the present disclosure is shown. More specifically, a more detailed view of a first fixed fastener 230 is shown. In some implementations, a fixed fastener of the present disclosure has a body 232 and a gate 234. In some cases, the gate is pivotally attached to the body. In some cases, the gate is lockable at a free end. In certain implementations of the fixed fastener of the present disclosure, the body is C-shaped, D-shaped, or so long as the body has a planar portion generally opposite the gate so that the fastener can be fixedly attached to a surface along a distance, then various shapes are possible.

Still referring to FIG. 2, one implementation of a fixed fastener according to the principles of the present disclosure is configured to reversibly receive a first tether 222 of a breakaway connector 220. In one implementation, the fixed fastener is attached via connectors 236, 238 to a pole 202 along the body 232. In some cases, the attachment is permanent. In some cases, the fastener is rivetted. In some cases, there are two or more rivets. It is to be understood that the attachment cannot be loose. Rather, the attachment should be secure and not moving. In some cases, the fastener is welded, riveted, bolted, or the like. It is important that there is no movement between two parts under normal conditions where a grounding current might be travelling.

Referring to FIG. 3, one implementation of a fixed fastener according to the principles of the present disclosure is shown. More specifically, in some implementations a fixed fastener of the present disclosure has a body 332 and a gate 334. In some cases, the gate is pivotally attached to the body via a hinge 340, or the like. In some cases, the gate is lockable at a free end 342. In certain implementations of the fixed fastener of the present disclosure, the body 332 is C-shaped, D-shaped, or so long as the body has a planar portion generally opposite the gate so that the fastener can be fixedly attached along a distance to a surface, then various shapes are possible.

Still referring to FIG. 3, one implementation of the fixed fastener of the present disclosure has a pair of recesses 344, 346 within the body opposite the gate that are configured to receive connectors 336, 338, e.g., rivets, screws, bolts, or the like. These connectors are configured to fixedly attach the fastener to a surface. In some cases, the fixed fastener is attached to an inside surface of a pole 302. In some cases, the fixed fastener is attached to an outside surface of a pole. In other cases, the fixed fastener is attached to a non-planar surface.

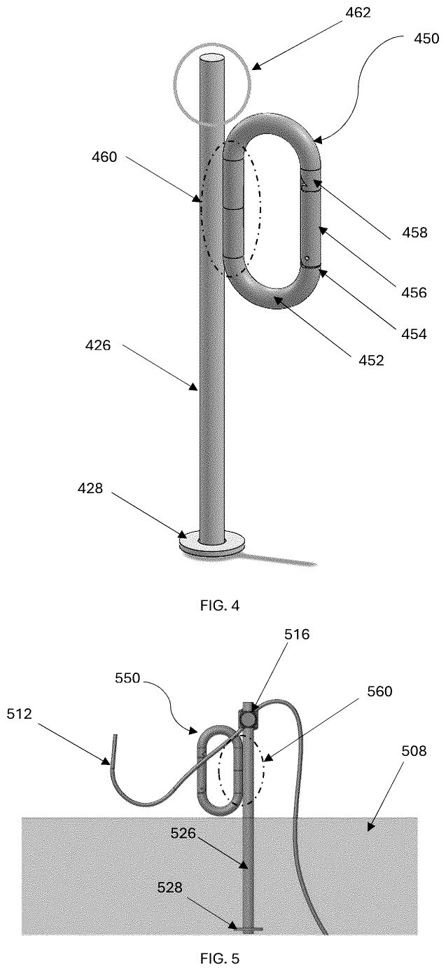

Referring to FIG. 4, another implementation of a fixed fastener according to the principles of the present disclosure is shown. More specifically, in some implementations a second fixed fastener 450 of the present disclosure has a body 452 and a gate 456. In some cases, the gate 456 is pivotally attached to the body via a hinge 454, or the like. In some cases, the gate is lockable at a free end 458. In certain implementations of the fixed fastener of the present disclosure, the body 452 is C-shaped, D-shaped, or so long as the body has planar portion generally opposite the gate so that the fastener can be fixedly attached along a distance to a surface, then various shapes are possible.

Still referring to FIG. 4, in one implementation a second fixed fastener 450 is fixedly mounted to a rod 426 having a base portion 428, the second fixed fastener being configured to reversibly receive a second tether of a breakaway connector. In certain implementations, the second fixed fastener 450 is fixedly mounted to a rod 426 a distance 462 from a free end of the rod to accommodate a nut. In certain implementations, the body of the fixed fastener is permanently attached along a planar portion 460 that is generally opposite the gate 456, using welding, epoxy, or the like. It is to be understood that the attachment cannot be loose. Rather, the attachment should be secure and not moving. In some cases, the fastener is welded, riveted, bolted, or the like. It is important that there is no movement between two parts under normal conditions where a grounding current might be travelling. In one implementation, welding the second fixed fastener 450 along a planar portion 460 to the rod 426 coming out of the concrete pole footing electrically bonds the fixed fastener to the rod, so they may be grounded as one item. Leaving a little extra length, or a distance 462, above the fixed fastener on the end of the rod allows a standard grounding clamp, as shown in FIG. 5 516 and conductor 512 to attach to the lower mount in the same way as a typical grounding conductor is clamped 118 to a grounding rod 114, as shown in FIG. 1.

Referring to FIG. 5, another implementation of a fixed fastener according to the principles of the present disclosure. More specifically, in certain implementations, the second fixed fastener 550 is fixedly mounted to a rod 526 a distance from a free end of the rod to accommodate a nut 516. In some cases, the rod 526 is held within the footer or pad 508 via a base 528 and is used to reversibly receive a second tether of a breakaway connector. In certain implementations, the body of the fixed fastener is permanently attached along a planar portion 560 using welding, epoxy, or the like.

In certain implementations, the fasteners according to the present disclosure are fixed since “loose” parts would all have to be grounded individually (typically with conductors attaching each part to a grounding rod (114). For the first fixed fastener, connectors 238 (e.g., rivets), or the like provides a positive connection that is secure and considered electrically bonded to the pole 202, which is already electrically grounded. Therefore, the grounding connection adequately carries over from the pole to the fixed fastener.

In contrast, current hardware uses a standard eyebolt bolted through the wall of the pole and a loose fastener attaching the eye to the connector tether. This is not electrically secure since the parts are “loose”.

In certain implementations, the second fixed fastener is secured to the rod coming out of the concrete pole footing and electrically bonds the fixed fastener to the rod, so they may be grounded as one item. The rod coming out of the ground is to hold the second fixed fastener in the event of an accident and is not used as a grounding rod. Grounding rods are usually copper or copper coated metal and must be driven a certain depth into the soil (e.g., earth ground). There is a limit on how many items can be grounded to a single grounding rod before another rod must be used.

In certain implementations, the tethers on the breakaway connector are coated and therefore electrically insulated and not considered part of the grounding scheme.

In some cases, electrically conductive materials vs non-conductive materials and strength are what drives the design. In certain implementations, stainless steel is used for the hardware to prevent corrosion, but galvanized steel would also be a possible choice. In some cases, aluminum is used as the pole is aluminum per the manufacturer. In some implementations, the parts are metal for strength, availability, and manufacturability (the processes are common), but using metal requires grounding.

In some cases, the insulative materials used in this assembly are: breakaway connector plastic housings, concrete “foundation” for the pole, and tether polyurethane sheathing. While it is possible to make the fixed fasteners out of something insulating, such as fiberglass, then grounding wouldn't be necessary. However, the negatives of non-metal options are cost, difficulty/time in development, weatherability, availability of materials, and finding suitable suppliers, for example.

Another consideration in material choice is that in some implementations, the strength for the whole assembly is 400 lbs of pull. The breakaway connector separates at a much lower force, but the breakaway connector and tethers, and the fixed fastener's size, and method of attachment, is expected to hold up to 400 lbs of force.

Various inventive concepts may be embodied as one or more methods, of which an example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

While various inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

When a feature or element is herein referred to as being “on” another feature or element, it can be directly on the other feature or element, or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one implementation, the features and elements so described or shown can apply to other implementations. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An implementation is an implementation or example of the present disclosure. Reference in the specification to “an implementation,” “one implementation,” “some implementations,” “one particular implementation,” “an exemplary implementation,” or “other implementations,” or the like, means that a particular feature, structure, or characteristic described in connection with the implementations is included in at least some implementations, but not necessarily all implementations, of the disclosure. The various appearances “an implementation,” “one implementation,” “some implementations,” “one particular implementation,” “an exemplary implementation,” or “other implementations,” or the like, are not necessarily all referring to the same implementations.

If this specification states a component, feature, structure, or characteristic “may”, “might”, or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various implementations of the disclosure are examples and the disclosure is not limited to the exact details shown or described.

While various implementations of the present disclosure have been described in detail, it is apparent that various modifications and alterations of those implementations will occur to and be readily apparent to those skilled in the art. However, it is to be expressly understood that such modifications and alterations are within the scope and spirit of the present disclosure, as set forth in the appended claims. Further, the disclosure(s) described herein is capable of other implementations and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the implementations of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other implementations are contemplated within the scope of the present disclosure in addition to the exemplary implementations shown and described herein. Modifications and substitutions by one of ordinary skill in the art are considered to be within the scope of the present disclosure.

What is claimed:

1. An attachment system for a grounding system, comprising:
a fastener body, comprising:
at least one planar portion; and
a gate opposite the at least one planar portion;
wherein the gate is pivotally attached to the body and has a free end, and the at least one planar portion is configured to be mechanically attached to a surface.

2. The attachment system for a grounding system according to claim 1, wherein the fastener body is configured to receive a tether of a breakaway connector.

3. The attachment system for a grounding system according to claim 1, wherein the surface is an inside surface of a pole.

4. The attachment system for a grounding system according to claim 1, wherein the planar portion further comprises a pair of recesses.

5. The attachment system for a grounding system according to claim 4, wherein fastener body is permanently attached using rivets via the pair of recesses.

6. The attachment system for a grounding system according to claim 4, wherein the pair of recesses are spaced along the planar portion of the body to distribute stress along a length of the planar portion.

7. An attachment system for a grounding system, comprising:
a fastener body, comprising:
at least one planar portion; and
a gate opposite the at least one planar portion;
wherein the gate is pivotally attached to the body and has a free end, and the at least one planar portion is configured to be permanently attached to a surface along a length of the planar portion.

8. The attachment system for a grounding system according to claim 7, wherein the fastener body is configured to receive a tether of a breakaway connector.

9. The attachment system for a grounding system according to claim 7, wherein the surface is a rod.

10. The attachment system for a grounding system according to claim 7, wherein the planar portion comprises a material.

11. The attachment system for a grounding system according to claim 9, wherein the fastener body is spaced a distance from a free end of the rod to accommodate a nut.

12. An attachment system for a grounding system, comprising:
a first fastener body, comprising:
a first planar portion; and
a gate opposite the first planar portion;
wherein the gate is pivotally attached to the first fastener body and has a free end, and the first planar portion is configured to be mechanically attached to a first surface; and
a second fastener body, comprising:
a second planar portion; and
a gate opposite the second planar portion;
wherein the gate is pivotally attached to the second fastener body and has a free end, and the second planar portion is configured to be permanently attached to a second surface along a length of the second planar portion.

13. The attachment system for a grounding system according to claim 12, wherein the first fastener body is configured to receive a first tether of a breakaway connector and the second fastener body is configured to receive a second tether of a breakaway connector.

14. The attachment system for a grounding system according to claim 12, wherein the first planar portion further comprises a pair of recesses.

15. The attachment system for a grounding system according to claim 12, wherein the first surface is an inside surface of a pole.

16. The attachment system for a grounding system according to claim 14, wherein the first fastener body is permanently attached using rivets via the pair of recesses.

17. The attachment system for a grounding system according to claim 14, wherein the pair of recesses are spaced along the first planar portion of the body to distribute stress along the length of the first planar portion.

18. The attachment system for a grounding system according to claim 12, wherein the second surface is a rod.

19. The attachment system for a grounding system according to claim 12, wherein the second planar portion comprises a material.

20. The attachment system for a grounding system according to claim 18, wherein the second fastener body is spaced a distance from a free end of the rod to accommodate a nut.
